(19) United States
(12) Patent Application Publication
(10) Pub. No.: US 2014/0319896 A1
(43) Pub. Date: Oct. 30, 2014

(54) DEVICE FOR ANCHORING A FALL RESTRAINT POST IN A SUPPORT STRUCTURE

(71) Applicants: CAPITAL SAFETY GROUP EMEA, Carros Cedex (FR); Dynamic Consult Monaco, Monaco (FR)

(72) Inventors: Vincent Meillet, Nice (FR); Thierry Partouche, Nice (FR)

(21) Appl. No.: 14/358,008

(22) PCT Filed: Nov. 13, 2012
(86) PCT No.: PCT/EP2012/072526

§ 371 Date: May 13, 2014

(30) Foreign Application Priority Data
Nov. 14, 2011 (FR) 1160318

(51) Int. Cl. A62B 35/00; E21F 11/00; E04H 12/22

(52) U.S. Cl. CPC A62B 35/0068; E04H 12/22; E21F 11/00
USPC 299/12; 29/525.01; 248/511; 405/232

(57) ABSTRACT

The present invention concerns a device (1) for anchoring a post (1a, 1b, 1c) in a support structure (2), a system with such a post (1a, 1b, 1c) being able to be a fall restraint protection system, an installation for protecting an area on a support structure (2), and a method for installing a post (1a, 1b, 1c). The anchoring device is characterized in that it comprises a securing means or member conformed so as to cooperate with the post (1a, 1b, 1c) for securing the post (1a, 1b, 1c) to said anchoring device (1) and in that the anchoring device (1) comprises a plate (7) raised with respect to the collar (4) so as to leave a space between the plate (7) and the collar (4), said plate (7) carrying said securing means or member. Application in the field of fixing a post, in particular for the fall restraint protection of personnel working in a dangerous area.

### TECHNICAL FIELD OF THE INVENTION

The present invention concerns a device for anchoring an element of the post type in a support structure, wherein this element may form part of a fall restraint protection system.

### PRIOR ART

Hereinafter, the present invention will be described in relation to a fall restraint protection system having a post to which protection elements are attached for each person to be protected against a fall. Such a system can in particular be used during civil engineering or for extraction industries for which drilling in the ground is carried out, wherein such drilling may serve for housing the anchoring device according to the present invention.

Civil engineering and extraction industries often require the use of explosives for fragmenting and extracting rocky materials or collapsing a section of ground, thus forming a quarry face. The technique employed consists of drilling regularly spaced holes close to a face using mechanized machinery, also referred to as drillers or drilling machines, and then filling in the drilled holes with explosive products, complying with very precise technical and safety rules. Because of the actual site conditions, for example collapse of the quarry face or reduced meshing because of vibratory constraints relating to the environment, some drillings are sometimes situated at a distance less than two meters from the edge of the quarry face. This use of explosive products in the immediate vicinity of the quarry faces requires the presence of several operators throughout this phase, referred to as charging blast holes. Work at less than two meters from an edge of a quarry face that is often high presents a high risk of falling for the personnel. As the height of such a face may be as much as fifteen meters or even several tens of meters, fall restraint safety for the personnel is required on an extraction site.

To limit the risks of falling of personnel working on an extraction site, either marking of the dangerous area or anchoring at least one individual fall restraint means on a fixed point has been proposed.

Marking has the advantage of clearly delimiting the protected area but does not afford any actual physical protection for the personnel guaranteeing the absence of possibility of a fall.

Anchoring on a fixed point is based on placing a mooring at the rear of the loading area, to which the personnel who have to work in the dangerous area anchor themselves by means of a harness, a fall restraint system or karabiners. The anchoring has many constraints that limit use thereof. Thus the mooring must be present whenever necessary, which is impossible in concrete terms.

For example, if it is site machinery, the machinery must be available at the precise moment when it is required, which is incompatible with the site production constraints. Moreover, the site equipment is immobilized from the time when the personnel require to be protected. In addition, if it is an inert mooring, for example a block of rock, the mooring must be moved in accordance with the progress of the work whenever necessary, using a suitable machine, which, there also, is incompatible with the site production constraints.

In addition, both for machinery and an inert mooring, in the case of multiplicity of areas requiring simultaneous special protection, anchoring to a mooring becomes purely and simply impossible to set up, since the time necessary for using the various anchorings bears no relationship to the period taken for executing the task to be performed. Finally, anchoring by mooring is unsuitable for work on unequal ground.

In the field of anchoring to a mooring, the document FR-A-2 822 073 describes individual protection equipment with a post anchored to an inert mooring that is a tree. This post comprises a ring providing an attachment point for a fall restraint system, such as a lifeline, secured to an operator. Such protection equipment has the drawbacks previously mentioned, in particular with regard to the impossibility of moving the inert mooring. In addition, this document relates to the protection of a person situated at a height on a tree, which is different from the protection of a person on a support structure, in particular the ground, in a protected area.

In the light of the teaching of this document, it can be envisaged providing a fall restraint protection system with a post able to follow the movements of the personnel and for this purpose being fixed to the ground placed at a point where the personnel are working, advantageously being partially buried in the ground. Such a fall restraint protection system with a post able to follow the movements of the personnel is however confronted with the problem of the stability thereof when the person connected to said system falls, the system having to resist the traction then exerted by the person falling in order to hold him. It is obvious that such resistance can be obtained only by an anchoring having certain guarantees of strength.

A known element of the post type intended to be at least partially introduced into the ground is illustrated in FIG. 1. This element comprises a lower part This forming the anchoring and intended to be housed in a drilling 2a made in the ground 2 as well as a upper part 3 projecting from the ground 2 while being substantially vertical. The upper part 3 comprises, toward its upper end, members, such as anchoring rings 5 from which it is possible to connect one or more automatic-return fall restraint systems and/or one or more lifelines so as enable one or more persons to be secured. A collar 4 is provided between the upper part 3 and the lower part 1bis of the element forming a post in order to at least partially close off the drilling 2a made in the ground 2 and also serve as a recessed abutment surface for the lower part 1bis.

Such an element forming a post has the disadvantage of being bulky while having a total length equal to the lengths of the upper 3 and lower 1bis parts. In addition, the lower part 1bis, while being subjected to bending forces caused by the traction operated on the anchoring rings 5, may easily break or enlarge the drilling 2a receiving it with the consequence of a unsatisfactory anchoring of the post in the ground 2. Finally, fitting the post in the drilling poses a problem because of the length of said post.

In general terms, for any element intended to be anchored firmly in a support structure, in particular the ground, this element being able to be a post and being in particular able to form part of a fall restraint protection system for one or more persons, the problem to be solved by the present invention is to effect for the post an insertion in the support structure that is strong while being easy to fit or remove.

### SUMMARY OF THE INVENTION

To achieve this objective, an anchoring device intended to be secured to an element of the post type is provided according to the invention, this device comprising an elongate part configured so as to be inserted in a support structure, the elongate part having, at its upper end, a collar intended to come into abutment against a top face of the support structure, characterized in that the anchoring device comprises securing means or member configured so as to cooperate with the post for connecting the post with said device. Preferably, the device also comprises a plate, also referred to as a deck, raised with respect to the collar so as to leave a space between the plate and the collar, said plate carrying said securing means or member.

Thus the plate and collar are disposed at a distance in the direction in which the elongate part extends.

The technical effect is firstly to obtain an easier fitting of the post, the anchoring device thereof being removable from said element and being able thus to be put separately in place by introduction into the drilled hole. Moreover, providing on the anchoring device a plate raised with respect to the collar affords an improved fitting of the post on the anchoring device thereof, procuring more space available for an operator for effecting the securing of the post with the anchoring device thereof.

In addition, as this installation takes place not at the support structure but above this structure, the interface between the post and the anchoring device is protected. For example, when the structure is the ground, the interface is protected from mud, dust, granulates, pebbles or stagnant water on the ground. This is particularly advantageous for protecting the means or member of securing between the anchoring device and the post.

The device according to the invention can also at least optionally have any one of the following and facultative features:
the anchoring device is configured so as to be maintained in place by gravity in the support structure, in the absence of any other locking system. Manual extraction thereof after use is therefore easy, and requires no tool or particular procedure.
reinforcements are provided between the collar and the raised plate. These reinforcements have the advantage of guaranteeing the strength of the collar and preventing any bending of the plate when the post is fitted,
advantageously, the plate forms a gripping area facilitating the manual extraction of the anchoring device out of the support structure after use,
said securing means or member is in the form of at least one eye having a recess, a connecting element of the pin type being inserted in said eye when the device is connected with the post. This connection comprising an eye through which a pin passes is the connection most suited to secure and rapid fitting under difficult working conditions for which the securing means or member may be dirty or blocked by various foreign bodies and may not be secured in a satisfactory manner by another form of connection, for example by screwing a fixing means or member,
the eye or each eye is in the form of a flange extending substantially perpendicular to the plane of the plate, at least one support means or member being provided for holding the flange in position with respect to the plate. Thus the eyes are spaced apart from the plate and made more accessible for passage of the associated pin,
the securing means or member comprise means or a mechanism for adjusting the inclination thereof with respect to the plate. This is particularly advantageous when the support structure is not flat or when it is necessary to take up clearance between an eye, the associated pin and the associated securing means or member carried by the post, for example when the corresponding securing means or member carried by the post and the anchoring device have been deformed,
the collar has an extension element passing through it, at least partially penetrating the elongate part while leaving between said extension element and the elongate part only a limited clearance just sufficient for insertion of the extension element in said elongate part. This extension element advantageously serves as a reinforcement for the elongate part over a certain part of the length thereof and guarantees rigidity of the portion of the anchoring device sunk in the support structure,
the length of the extension element penetrating the elongate part is at least equal to one fifth of the length of the elongate part. The purpose of this is to ensure sufficient rigidity for the elongate part, which is essentially required for the upper portion of said elongate part,
the face of the plate opposite the collar forms a stop for the upper end of the extension element and/or of the elongate form. Thus the plate is subjected firstly to the weight of the post, weight that is counterbalanced by the stop action of the end of the extension element and/or of the elongate part, then exerting a support action for the plate,
the elongate part, the plate and the collar form a single-piece assembly,
the collar has a maximum dimension in a transverse direction that is substantially perpendicular to the direction in which the elongate part extends. Non-imitatively, this maximum dimension is greater than or equal to twice the maximum dimension of the elongate part in this same transverse direction.

The invention also concerns a system comprising an element of the post type to be fixed with respect to a support structure, characterized in that it comprises such a device for anchoring in the support structure, the anchoring device being removable from the post and the post comprising supplementary means of connection to the connection means of the anchoring device. There is thus obtained a facilitated fitting of the system by installing first of all the anchoring device without the post being secured to said device, which makes the anchoring device easier to handle for introduction thereof into the support structure, for example a hole drilled in the ground.

Advantageously, the system is a fall restraint protection system carrying at least one set of individual means for protecting a person.

The invention also concerns an installation for protecting an area on a support structure, characterized in that it comprises at least one fall restraint protection system.

In a first embodiment, the protection system comprises a fall restraint protection system, the individual protection means for each person to be protected comprising a fall restraint system with one end of the fall restraint system fixed to said system while the other end thereof is fixed to said person by means of a fall restraint harness. This embodiment makes it possible, by using only one system, to define a safety area in an arc of a circle centered on the post.

In a second embodiment, the protection installation comprises two fall restraint protection systems, the individual protection means comprising a lifeline connecting the two protection systems and, for each person to be protected, a fall restraint system with one end of the fall restraint system fixed with freedom of sliding along the lifeline while the other end thereof is fixed to said person by means of a fall restraint harness.

This allows a movement of the protected person or persons on the same lifeline and therefore affords a larger safety area than for the first embodiment, this area being substantially rectangular.

Finally, the invention concerns a method of installing such a protection installation comprising at least one element of the post type to be fixed with respect to a support structure, characterized in that it comprises the following steps:
introduction of the or each anchoring device separate from the corresponding post thereof,
positioning the corresponding post above the anchoring device thereof and in line with said device,
securing the post to the anchoring device thereof.

Advantageously, the method comprises, prior to the introduction step, a step of drilling at least one drilling hole in the ground of a quarry, the anchoring device then being introduced into this drilling hole during the introduction step.

Advantageously, for the method of installing a protection installation, which is operative on the ground of a quarry having a quarry face, a safety perimeter is defined limiting the movement of at least one person connected to the protection installation, said perimeter keeping said person at a safety distance from the quarry face.

Advantageously, for such a method of installing a protection installation, which is operative on a support structure, for which structure a collapse or fragmentation is carried out by the use of an explosive on a portion of said structure, explosives being placed in drilling holes in order to effect this collapse or fragmentation, a step of introducing an anchoring device by gravity is then performed in a drilling hole having the same dimensions as the drilling holes for explosives. Thus a single tool may be used for drilling both the drilling holes for explosives and a drilling hole for the anchoring device.

The solution proposed by the present invention is particularly well suited for installing a fall restraint protection system on a site, in particular for a quarry that may have blast holes. The anchoring device is introduced into an already existing blast hole and/or into a hole that may be produced specifically for this use but the drilling of which occurs during the drilling of other blast holes. There is therefore no need for any specific material for installing the fall restraint protection system, for example a mooring as described in the prior art, nor any specific action separate from the production operations, the drilling specific to the housing of the anchoring device being integrated in the time devoted to the other drillings.

### BRIEF DESCRIPTION OF THE FIGURES

Other features, aims and advantages of the present invention will emerge from a reading of the following detailed description with regard to the accompanying drawings given by way of non-limitative example and in which:

FIG. 1 is an illustration of the principle of a known retractable anchoring,

FIG. 2 is a view in perspective of the anchoring device according to the present invention,

FIG. 3 is a view in section of part of the anchoring device according to the present invention, this figure showing in particular the collar of the anchoring device carried at the top end of the elongate part of said device,

FIG. 4 is a plan view of the anchoring device according to the present invention, this figure showing in particular the fixing eyes carried by a plate superimposed on the collar of said device,

FIG. 5 is an illustration of an installation for protecting an area comprising a fall restraint protection system according to the present invention, this protection being effected over an angular sector, this installation being according to a first embodiment in accordance with the present invention,

FIG. 6 is an illustration of an installation for protecting an area with two fall restraint safety systems according to the present invention, the two systems being joined by a lifeline, this installation being according to a second embodiment in accordance with the present invention,

FIG. 7 is a perspective view of an anchoring device according to the present invention operatively connected to an upper part,

FIG. 8 is a front view of the anchoring device shown in FIG. 7,

FIG. 9 is a side view of the anchoring device shown in FIG. 7,

FIG. 10 is rear view of the anchoring device shown in FIG. 7.

### DETAILED DESCRIPTION OF THE INVENTION

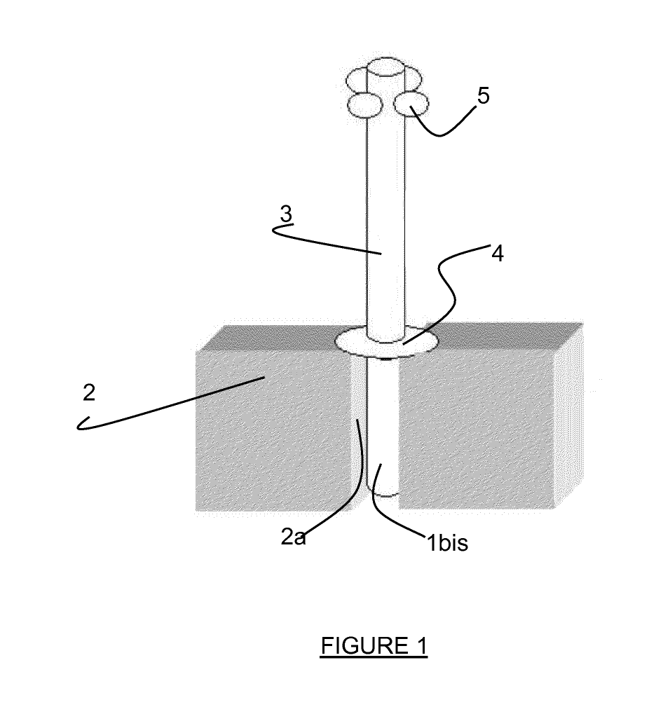

FIG. 1 has already been detailed in the introductory part of the present patent application.

Hereinafter, the anchoring device will be described while being buried in the ground. This is not limitative and such an anchoring device may be used while being inserted in any support structure, for example a metal, concrete, or timber surface.

The terms upper and lower are used considering the anchoring device positioned in the support structure, mainly the ground, the anchoring device then extending substantially vertically.

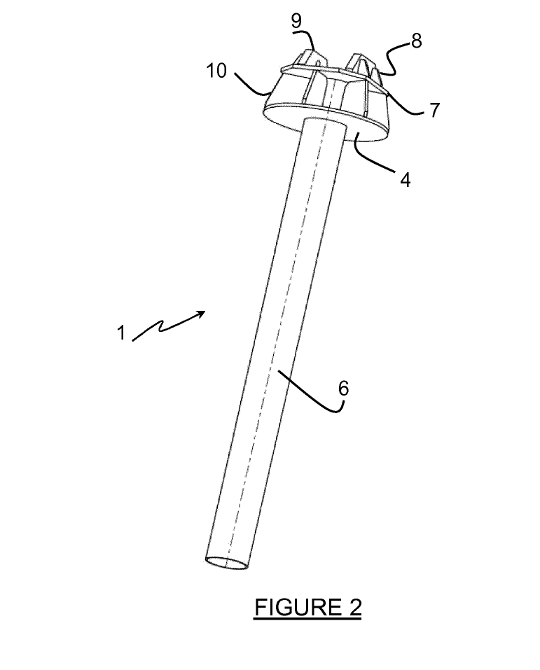

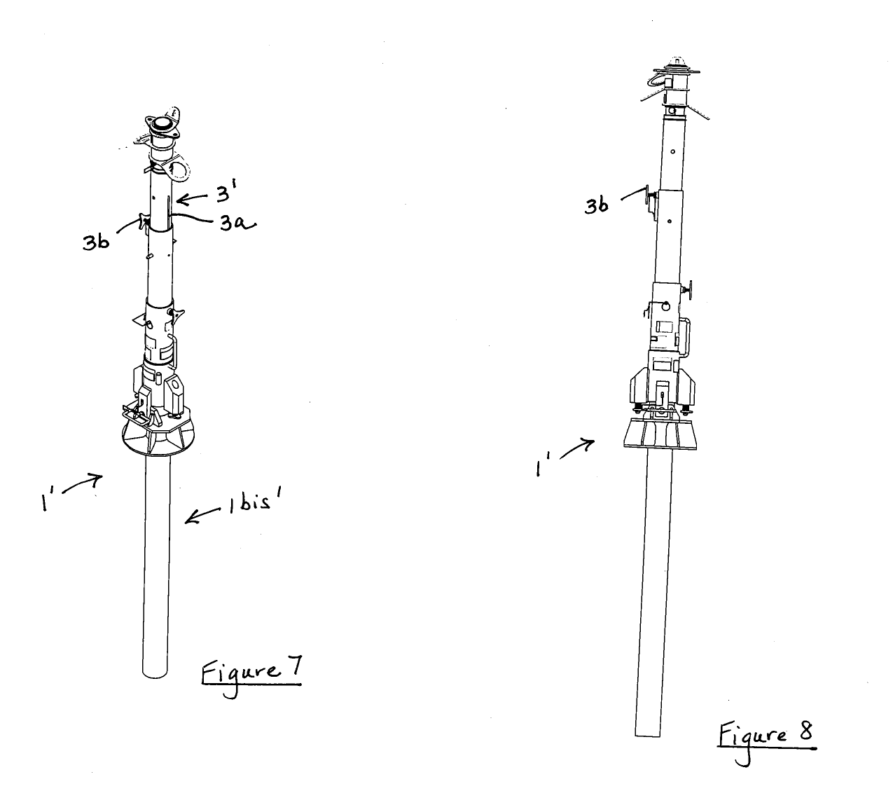

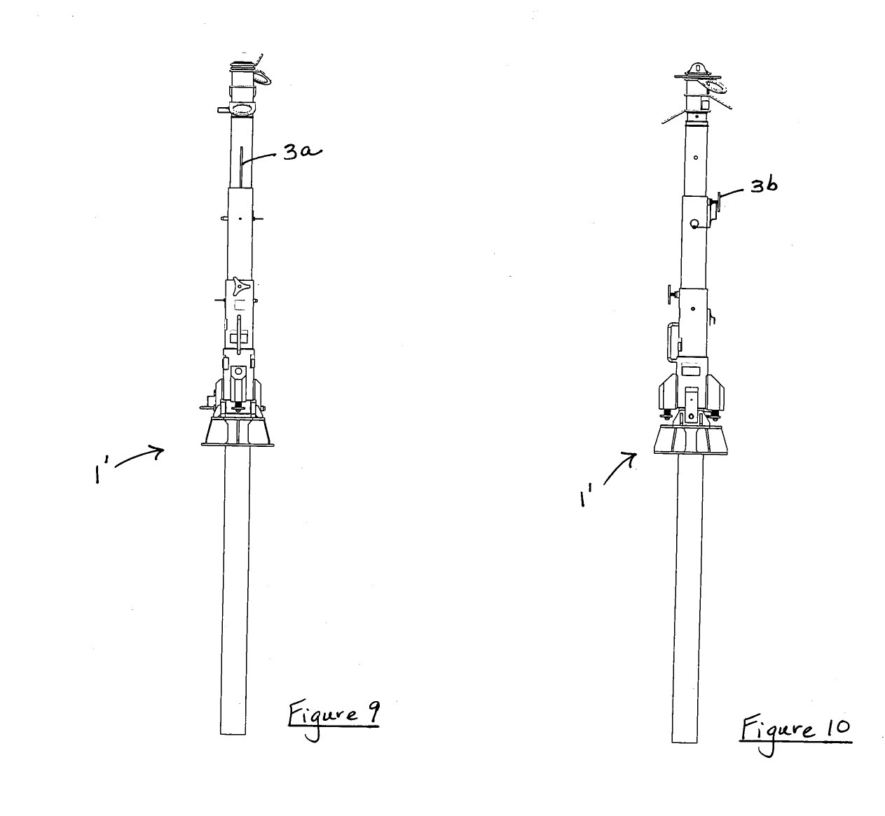

Referring to FIG. 1, unlike the principle of a known retractable anchoring illustrated in this figure, the present invention provides an element of the post type with upper 3 and lower 1bis parts independent of each other. An example of an anchoring device 1′ including a lower part 1bis′ operatively connected to an upper part 3′ is shown in FIGS. 7-10. According to the present invention, the lower part 1bis is replaced by a removable anchoring device for the upper part 3. The anchoring device is secured to the upper part 3 and is provided with securing means or member for receiving the upper part 3 after insertion thereof in the support structure. Thus the installation of the post is facilitated, the anchoring device being introduced into the hole 2a, advantageously a drilling, before said device receives the upper part 3 at its upper end and is secured to said upper part 3. Such an anchoring device will be seen more clearly in FIG. 2.

FIG. 2 illustrates an anchoring device 1 implementing the lower part 1bis of the post and intended to be anchored partially in the ground forming the support structure, this device 1 forming an entity separate from the post.

The anchoring device 1 according to the invention comprises an elongate-shaped part 6 advantageously metal and preferably cylindrical. This elongate part 6 is intended to be introduced into a hole formed in the ground, advantageously in a drilling already made for another purpose or in a drilling that may be made with the same tool as the drillings possibly already made on the site. In use, the anchoring device 1 is maintained in the hole of the support by gravity. Only the contact or contacts between the elongate-shaped part 6 and the walls of the hole as well as the contact between the bottom face of the collar 4 and the support hold the anchoring device 1 in position. Thus the latter does not require any additional fixing means or member such as screws in order to be held in the support during use. The installation and removal of the anchoring device 1 in and out of the support are therefore particularly easy.

The anchoring device 1 also comprises a collar 4 that is arranged at one end of the elongate part 6. The collar 4 is preferably in a single piece with said part 6. This collar 4 is mainly intended to block, while covering it on top, the hole in which the elongate part 6 is introduced as well as to support a plate 7 that will be described subsequently. This collar 4 also serves as a recessing stop, preventing the elongate part 6 being even further deeply recessed in the ground, the hole being able to be longer than the elongate part 6.

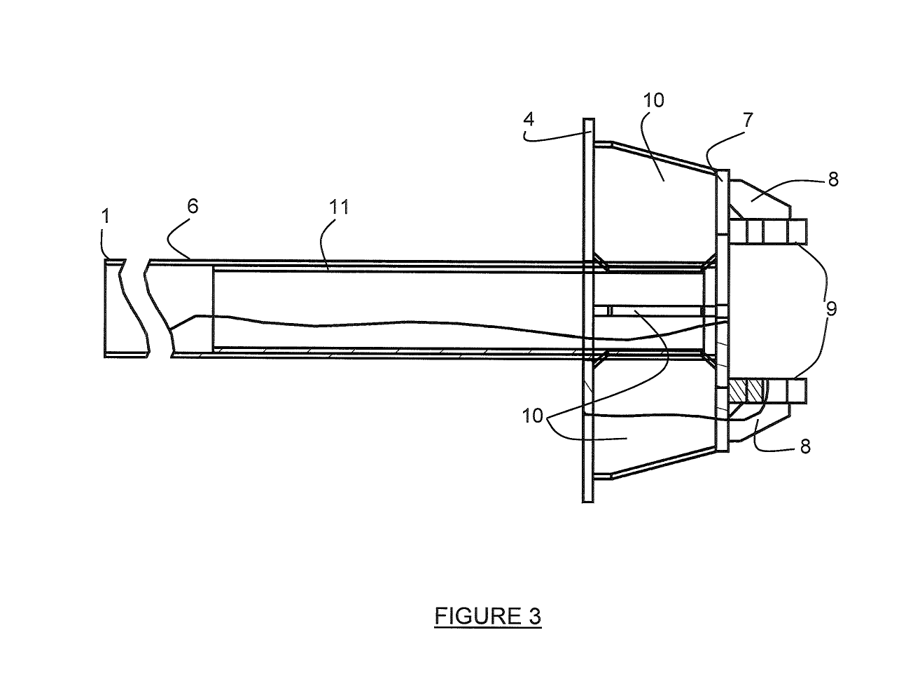

The elongate part 6 is advantageously in the form of a hollow metal tube or is hollow at least partially over a predetermined length at its end carrying the collar 4 so as to receive inside it an extension element secured to the collar 4, an extension element that will be described below in relation to FIG. 3.

The elongate part 6 has dimensions adapted to the hole receiving it. The walls thereof are fairly thick and made from a material suitable for being able to withstand bending forces that the post will transmit to it once completely mounted on and secured to the anchoring device 1.

For example, the elongate part 6 may have an outside diameter of approximately 76.1 mm for insertion thereof in a hole with a diameter of 89 mm or an outside diameter of approximately 101.6 mm for insertion thereof in a hole with a diameter of 115 mm. The length of such an elongate part 6 may be approximately 1.20 m. This enables the device 1 to be positioned in a sufficiently deep part of the ground in order to be considered to be secure, and therefore configured and arranged for withstanding the forces generated during high bending of the post. The elongate part 6 may be positioned by gravity in the hole or drilling while being placed vertically above the hole.

The purpose of the collar 4 is to carry a connection means or member of the anchoring device 1 while raising the connection means or member with respect to the ground, connection means or member that are mainly dedicated to securing the anchoring device 1 to the post, said post carrying complementary securing means or member.

The connection means or member for securing the anchoring device 1 is provided on a plate 7 carried by the collar 4. The plate 7 forms a substantially flat horizontal surface in the position of the anchoring device 1 inserted in the hole, said surface of the plate 7 being placed above and at a distance from the substantially flat horizontal surface formed by the collar 4. The plate 7 carries at least one flange with a fixing eye 9 on its top face, forming the connection means or member carried by the anchoring device 1.

The plate 7 is raised with respect to the collar 4 and therefore with respect to the ground, advantageously by approximately 100 mm above the ground. This allows easy access for an operator to the fixing eyes 9, in particular should water be present on the area of use. This also avoids the exposure of the fixing eyes 9 and the complementary securing means or member thereof carried by the post, once said post is installed, to mud, dust and granulates that may jam or interfere with the functioning thereof. Finally, the plate 7 makes it possible to manually extract the anchoring device 1 after use. It offers in fact a good gripping surface, easily accessible.

Each fixing eye 9 is advantageously provided with a recess for passage of a securing means or member, advantageously a pin, preferably a detent pin. The complementary securing means or member carried by the bottom part of the post may also carry a recess through which the corresponding pin passes in the position of connection of the anchoring device 1 and the post.

In FIG. 2, the plate 7 comprises two fixing eyes 9. Each fixing eye 9 is in the form of a flange extending substantially vertically, the flanges of the two fixing eyes 9 being substantially parallel. Advantageously, the post also has two eyes in the form of substantially vertical flanges that are either positioned between the fixing eyes 9 of the anchoring device 1 or positioned outside the forming eyes 9 of the anchoring device 1 in order to prevent radial movement of the post with respect to the anchoring device 1. As an alternative to the flanges, one or more eyes 9 on the anchoring device 1 may have a circular shape in which a complementary shape carried by the mast fits or which is surrounded by said shape.

Each fixing eye 9 may have at least one support means or member 8 for holding the eye 9 in position, for example in order to prevent the eye 9 twisting. The support means or member 8 may advantageously each have a triangular section with one side of the triangle in abutment on the plate 7.

Between the plate 7 and the collar 4, reinforcements 10 are also provided in order to support the plate 7, these reinforcements 10 resting on the collar 4. These reinforcements 10 each advantageously extend on a radius of the collar 4.

As the ground may be more or less flat and the plate 7 may be more or less sloping with respect to a horizontal plane, a means of compensating for the declivity of the ground is advantageously provided for each eye 9, this means not being shown in the figures. This compensation means may be a screw system making it possible not only to compensate for the inclination in the case of use on an inclined ground but also taking up the clearance between the pin and the recess in the eye 9 and also taking up the clearance between the post and the anchoring device 1.

As can be seen more clearly in FIG. 3, the collar 4 has an extension element 11 passing through it that extends perpendicular to and in the opposite direction to the face of the plate 7 when the anchoring device 1 is in position inserted in the hole. The top end of the extension element 11 advantageously abuts against the bottom face of the plate 7, this bottom face being opposite the collar 4. Part of this extension element 11 extends from the collar 4 toward the elongate part 6 and is received in a hollow portion provided in said elongate part 6 or inside the tube formed by the elongate part 6. Thus the elongate part 6 has increased rigidity because of the insertion of part of the extension element 11 inside it.

To give an idea, without this being imitative, taking an elongate part 6 of approximately 1 meter 20, the part of the extension element 11 entering the elongate part 6 may be 40 cm. In general terms, the length of the part of the extension element 11 entering the elongate part 6 may vary from one fifth to more than half of the length of the elongate part 6.

The extension element 11 may be cylindrical, advantageously in the form of a tube. Advantageously, for a drilling hole 89 mm in diameter and therefore an elongate part 6 with an outside diameter of 76.1 m, the extension element 11 may be in the form of a tube having an outside diameter of 68.5 mm with a wall thickness of 4.5 mm, this outside diameter being calculated so as to provide a limited clearance between the extension element 11 and the elongate part while providing a sufficient increase in the strength, in particular the bending strength, of the elongate part 6. Likewise, for a drilling hole 115 mm in diameter and therefore an elongate part 6 with an outside diameter of 101.6 mm, the extension element 11, advantageously in the form of a tube, may have an outside diameter of 92.5 mm with a wall thickness of 10.75 mm.

Advantageously, the end of the part of the extension element 11 inserted between the collar 4 and the plate 7 abuts against the bottom face of the plate 7. The part of the extension element 11 inserted may also have on its periphery shapes cooperating with complementary shapes, for example carried by the reinforcements 10 between plate 7 and collar 4. This ensures holding of the extension element 11 between collar 4 and plate 7, in particular to prevent it from rotating with respect to the collar 4 and plate 7.

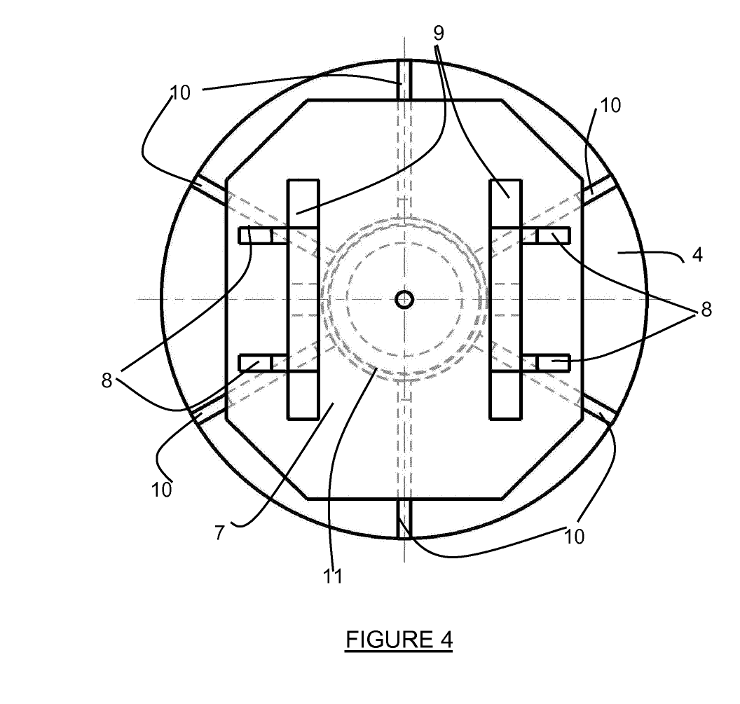

In FIG. 4, it can be seen that the collar 4 has a circular periphery while the plate 7 has an octagonally shaped contour, the plate 7 having a smaller surface area than the collar 4, but this is not required. It can also be seen that the edges of the reinforcements 10 most internal to the collar 4 are in abutment against the extension element 11, the reinforcements being six in number in this example. The eyes 9 are also particularly visible, two in number and in the form of a respective flange, the flange of one eye 9 being parallel to the flange of the other eye 9. The distance between the two flanges may correspond substantially to the diameter of the extension element 11, the flanges resting on the top face of the plate 7 while being superimposed at the end of the extension element 11.

As previously mentioned, the anchoring device 1 according to the present invention is intended to receive an element of the post type, the post type element comprising complementary means of connection to the connection means or member (eyes 9) of the anchoring device 1. This post type element is advantageously the body of a fall restraint protection system for one or more persons. The anchoring device 1 is, however, not limited to this use and may concern the anchoring of other elements, such as for example a column, a stanchion or an equivalent element in an advantageously substantially flat support structure, in particular the ground.

The number of persons who can be protected on a single fall restraint protection system according to the present invention is limited, this number depending mainly on the diameter of the elongate part 7 of the anchoring device 1. For example, an elongate part 6 with a diameter of 76.1 mm, intended for a drilled hole with a diameter of 89 mm, can protect up to three persons at a maximum, and an elongate part 6 with a diameter of 101.6 mm, intended for a drilled hole with a diameter of 115 mm, can protect up to four persons at a maximum.

Such a fall restraint protection system can be used advantageously on a quarry face in a quarry but also finds many other applications. For example, such a system can be used at a height, in particular in construction works, for example at the top of buildings, the anchoring device being fixed for example in a concrete surface, in particular a concrete slab.

Advantageously, the post is telescopic, being able to be composed of several hollow cylindrical parts having a smaller diameter further away from the anchoring device, these cylindrical parts being able to enter one another in the retracted position of the post.

Advantageously, the cylindrical parts can be provided with a groove 3a in which a locking means or member 3b enters. This groove 3a, advantageously longitudinal, can make it possible to lock a cylindrical part with respect to the cylindrical part preceding it and able to contain it, in order to hold the cylindrical part either in a retracted position or in a deployed position with respect to the cylindrical part preceding it. The groove and/or another groove, advantageously transverse, may also be used for preventing two adjacent cylindrical parts from rotating with respect to each other or at least to limit such rotation.

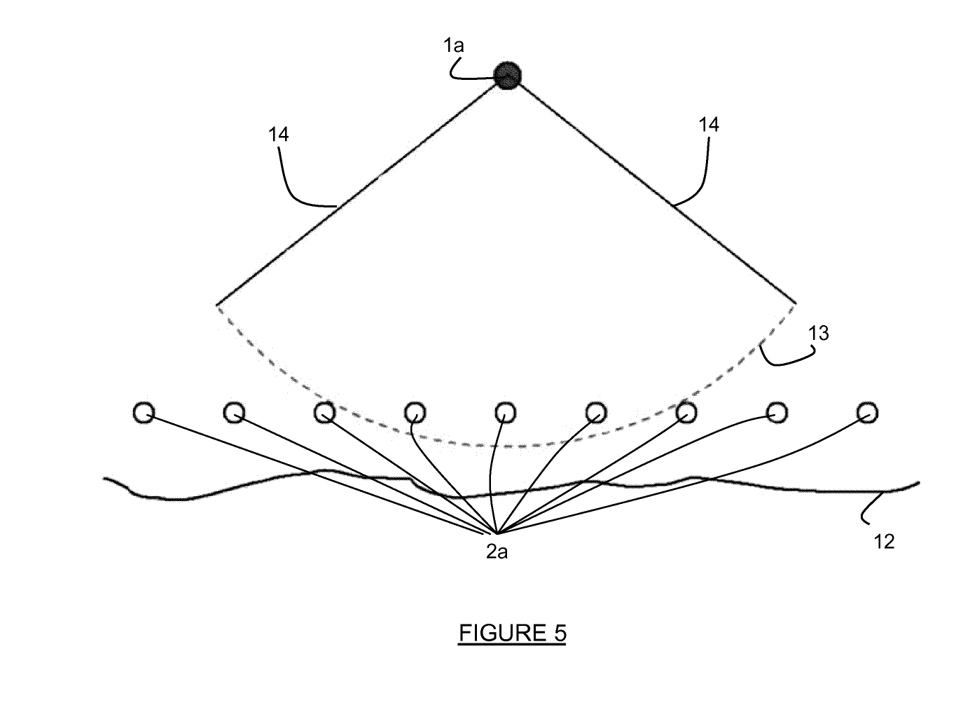

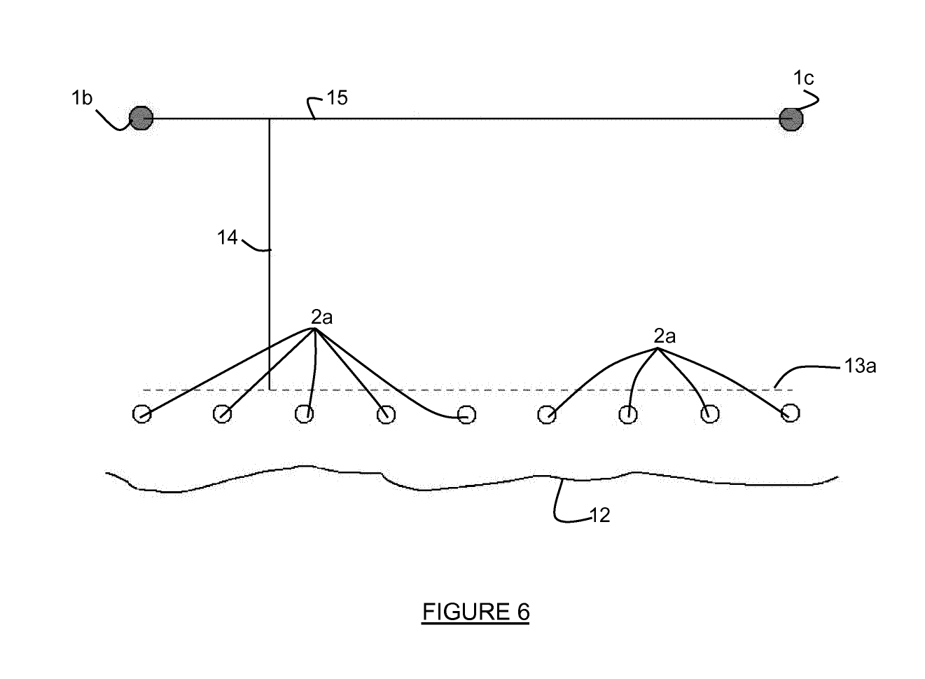

As shown in general terms in FIG. 1, rings 5 or hooks are provided toward the top part of the post type element in order to attach it to an individual element for protecting a person, this element advantageously being a fall restraint system 14 as will be seen in FIGS. 5 and 6. Typically, the fall restraint system 14 is a lanyard or a lifeline with or without automatic return.

With regard to the safety field, a fall restraint protection system for one or more persons with an anchoring device according to the present invention can form part of an installation for protecting an area on a support structure, comprising one or more elements forming a post.

FIGS. 5 and 6 show embodiments of a protection installation comprising at least one fall restraint protection system according to the present invention. Taking the non-limitative example of a quarry with a quarry face, the installation can take two different embodiments for adapting to the different configurations of placement of the drilling holes to be dealt with.

FIG. 5 shows a protection installation on an angular sector with a single safety system while FIG. 6 shows a protection installation with at least two safety systems joined by a lifeline, thus protecting a rectangular sector.

In FIG. 5, the protection installation comprises a single anchoring post 1a. The post 1a is placed at the rear of drilled holes 2a and is used as a fixed attachment point. One or more protected persons can work in a protected area limited toward the quarry face 12 by the limit arc of a circle 13 in broken lines and laterally by straight lines illustrating the link between a person and the post 1a, this link being in the form of a fall restraint system 14 such as a lanyard or a lifeline connected on the one hand to the harness carried by the protected person and on the other hand to the post 1a.

Once the lanyard or lifeline connecting the protected person to the post 1a has been tensioned, the protected person can travel over the limit arc of a circle 13 moving closer to the quarry face 12 while being protected in the event of a fall.

FIG. 6 shows a protection installation using a lifeline 15 connecting two post type elements 1b and 1c. The two posts 1b and 1c are placed at the rear of the series of drilled holes 2a, the series being situated close to the face line 12. The lifeline is in the form of a tensioned cable 15 from post 1b to post 1c. It is to this cable that the protected person or persons are connected by their respective fall restraint system 14, the end of the fall restraint system 14 connected to the lifeline 15 being able to slide on said line 15. The limit line 13a in broken lines shows the points closest to the face 12 that can be reached by the protected person or persons.

Once a person is connected to the lifeline 15 by one end of a fall restraint system 14, with freedom of sliding of the fall restraint system 14 along the lifeline 15, the other end of the fall restraint system 14 being connected to the harness that the person is wearing, the person can travel over an area adjacent to the face 12 over its entire length with fall restraint protection. In order to guarantee safety of the protection installation, the posts 1b and 1c can advantageously accept a horizontal lifeline with automatic return of the EZ-LINE™ type.

Referring to the figures of the present application, the present invention concerns a method of installing such a protection installation comprising at least one post 1a, 1b, 1c to be fixed with respect to a support structure 2, characterized in that it comprises the following steps:
introducing by gravity the or each anchoring device 1 separate from its corresponding posts 1a, 1b, 1c in the support structure 2,
positioning the corresponding posts 1a, 1b, 1c above its anchoring device 1 and in line therewith,
securing the posts 1a, 1b, 1c to its anchoring device 1.

A safety system composed of a post connected to its anchoring device is extremely bulky. To avoid this, the present invention proposes to provide an anchoring device independent of its post, to first of all fit only the anchoring device in the support structure, this device having a smaller size than with its post and then to secure the post to its device, which affords facilitated installation of the safety system in position in the structure.

A preferential but not imitative application of the present invention provides for the protection installation to be installed on the ground 2 of a quarry having a quarry face 12, the ground 2 then forming the support structure. In this case, the method provides for the definition of a safety area limiting the movement of at least one person connected to the protection installation, said area keeping said person at a safety distance from the quarry face 12.

When, on the structure for installing the protection installation, collapse or fragmentation is carried out by the use of explosives on a portion of said support structure 2, explosives being placed in drilling holes 2a in order to effect this collapse or fragmentation, the installation method advantageously provides for the step of introducing an anchoring device 1 by gravity is then carried out in a drilling hole 2a having the same dimensions as the drilling holes 2a. Thus a single drilling tool can produce the drilling holes 2a for the use of explosives and also the drilling holes 2a for the anchoring devices 1, which is a simplification in the working equipment required on site.

The advantages of the present invention are numerous. A first advantage is that the anchoring device according to the invention is easy to install and to dismantle, while being strong in use.

A second advantage is that the collar and plate present on the anchoring device make it possible to raise the securing means or member of the anchoring device with the post and thus to protect the securing means or member whilst facilitating access to said securing means or member.

A third advantage is that the extension element stiffens the elongate part and therefore the entire anchoring device assembly in a simple manner, over the length just necessary for such stiffening at the top portion of the elongate part.

A fourth advantage is that the eyes 9 in the form of a flange advantageously make it possible to limit the lateral clearance between the anchoring device and the post.

The fall restraint safety system with such an anchoring device is in particular adaptable to numerous types of situations, whether it be in a quarry or in the construction field. On a quarry with a quarry face, such an installation protects the person or persons against any fall close to a quarry face.

Such a protection system is more self-contained and does not require any external equipment. Such a system, because of the separation of the post from its anchoring device, is also easily removable and transportable, in particular in a light vehicle. The system can be used whatever the type of rocky material and whatever the climatic conditions. The system is simple and can be handled manually by one or more operators.

### REFERENCES

1. Anchoring device
1bis. Lower part
1a. Post
1b. Post
1c. Post
2. Ground
2a. Drilling
3. Upper part
4. Collar
5. Anchoring ring
6. Elongate part
7. Plate
8. Support means or member
9. Eye
10. Reinforcement
11. Extension element
12. Quarry face
13. Limit arc of a circle
13a. Limit line
14. Fall restraint system
15. Lifeline

1. An anchoring device (1) intended to be secured to a fall restraint post (1a, 1b, 1c), comprising:
an elongate part (6) configured so as to be inserted in a support structure (2), the elongate part (6) having, at its top end, a collar (4) intended to come into abutment against a top face of the support structure (2), characterized in that the anchoring device (1) comprises a connection member conformed so as to cooperate with the post (1a, 1b, 1c) for securing the post (1a, 1b, 1c) to said anchoring device (1) and in that the anchoring device (1) comprises a plate (7) raised with respect to the collar (4) so as to leave a space between the plate (7) and the collar (4), said plate (4) carrying said connection member.

2. An anchoring device (1) according to claim 1, in which reinforcements (10) are provided between the collar (4) and the raised plate (7).

3. An anchoring device (1) according to claim 1, for which said connection member is in the form of at least one eye (9) having a recess and configured so as to receive a connecting element of a pin type inserted in the said eye (9) when the anchoring device (1) is secured to the post (1a, 1b, 1c).

4. An anchoring device (1) according to claim 3, for which the eye or each eye (9) is in the form of a flange extending substantially perpendicular to the plane of the plate (7), at least one support member (8) being provided for holding the flange in position with respect to the plate (7).

5. An anchoring device (1) according to claim 1, for which the connection member comprises a screw system configured and arranged to adjust the inclination thereof with respect to the plate (7).

6. An anchoring device (1) according to claim 1, wherein the collar (4) has an extension element (11) passing through it, at least partially entering the elongate part (6) while leaving between said extension element (11) and the elongate part (6) only a limited clearance just sufficient for inserting the extension element (11) in said elongate part (6).

7. An anchoring device (1) according to claim 6, wherein a length of the extension element (11) entering the elongate part (6) is at least equal to one fifth of a length of the elongate part (6).

8. An anchoring device (1) according to claim 6, for which a face of the plate (7) opposite the collar (4) forms a stop for the top end of one of the extension element (11) and the elongate part (6).

9. An anchoring device (1) according to claim 6, wherein the elongate part (6), the plate (7) and the collar (4) form a single-piece assembly.

10. An anchoring device (1) according to claim 6, wherein the collar (4) has a maximum dimension in a transverse direction that is substantially perpendicular to a direction in which the elongate part (11) extends, and that is greater than or equal to twice a maximum dimension of the elongate part (11) in this same transverse direction.

11. An anchoring device (1) according to claim 1, the anchoring device (1) being removable from the post (1a, 1b, 1c) and the post (1a, 1b, 1c) comprising a securing member complementary to the connection member of the anchoring device (1).

12. An anchoring device (1) according to claim 1, the anchoring device (1) carrying at least one individual element (5, 14, 15) for protecting a person.

13. (canceled)

14. An anchoring device (1) according to claim 12, wherein the individual element (5, 14, 15) comprises, for each person to be protected, a fall restraint system (14) having one end of the fall restraint system (14) configured so as to be fixed to said anchoring device and another end configured so as to be fixed to a fall restraint harness of said person.

15. An anchoring device (1) according to claim 12, wherein the individual element (5, 14, 15) comprises a lifeline (15) connecting the anchoring device (1) to another anchoring device (1) and, for each person to be protected, a fall restraint system (14) with one end of the fall restraint system (14) fixed with freedom of sliding along the lifeline (15) while its other end is fixed to a fall restraint harness of said person.

16. An anchoring device (1) according to claim 15, in which the fall restraint system (14) is a lifeline.

17. A method of installing a protection installation, comprising:
introducing by gravity an anchoring device (1) separate from its corresponding post (1a, 1b, 1c) in the a support structure (2),
positioning the corresponding post (1a, 1b, 1c) above its anchoring device (1) and in line with said anchoring device (1),
securing the post (1a, 1b, 1c) to its anchoring device (1).

18. A method of installing a protection installation according to claim 17, comprising, prior to the introducing by gravity step, a step of drilling at least one drilling hole (2a) in the support structure, the anchoring device then being introduced into this drilling hole (2a) during the introducing by gravity step.

19. A method of installing a protection installation according to claim 17, wherein the support structure is a ground (2) of a quarry or mine having a quarry face (12), wherein a safety area is defined limiting movement of at least one person connected to the protection installation, said area keeping said person at a safe distance from the quarry face.

20. A method of installing a protection installation according to claim 17, which is operative on the support structure (2), for which a collapse or fragmentation is carried out on a portion of said support structure (2) through the use of explosives, explosives being placed in drilling holes (2a) in order to effect this collapse or fragmentation, the step of introducing by gravity the anchoring device (1) being performed in a drilling hole (2a) having the same dimensions as the drilling holes (2a) for the use of explosives.
